(19) United States
(12) Patent Application Publication
(10) Pub. No.: US 2023/0418855 A1
(43) Pub. Date: Dec. 28, 2023

(54) FILE SEARCH SYSTEM, FILE SEARCH METHOD, AND RECORDING MEDIUM WITH FILE SEARCH PROGRAM RECORDED THEREON

(71) Applicant: SHARP KABUSHIKI KAISHA, Sakai City (JP)

(72) Inventor: YUUSUKE NAKATANI, Sakai City (JP)

(21) Appl. No.: 18/208,910

(22) Filed: Jun. 13, 2023

(30) Foreign Application Priority Data
Jun. 22, 2022 (JP) 2022-100196

(51) Int. Cl. G06F 16/33; G06F 40/205; G06F 40/242

(52) U.S. Cl. CPC G06F 16/3349; G06F 16/3334; G06F 40/205; G06F 40/242

(57) ABSTRACT

A file search system includes an acquisition processing unit that acquires a search keyword for searching a predetermined file in a storage storing a plurality of files; a search processing unit that searches the predetermined file on the basis of the search keyword acquired by the acquisition processing unit; and an output processing circuit that outputs a search result of the search processing circuit and outputs a degree of relatedness representing a relationship between the search keyword and each of the files stored in the storage on a basis of a score value corresponding to appearance frequency of the search keyword, the score value corresponding to each of the files.

### INCORPORATION BY REFERENCE

This application is based upon and claims the benefit of priority from the corresponding Japanese Patent Application No. 2022-100196 filed on Jun. 22, 2022, the entire contents of which are incorporated herein by reference.

### BACKGROUND

The disclosure relates to a file search system, a file search method, and a recording medium with a file search program recorded thereon.

Conventionally, a system is known that searches for a search target matching a search keyword in multiple search targets stored in a storage. For example, when a system that retrieves a specific document file from multiple document files stored in a storage acquires a search keyword entered by a user, the system performs a full-text search of the content (documents) in each of the document files and extracts document files containing the search keyword.

However, with a conventional technique, when there are many files to search, it becomes difficult for users to obtain their desired files because more files than expected are extracted. Moreover, the user needs to enter the search keyword repeatedly until a desired file is obtained.

### SUMMARY

An object of the disclosure is to provide a file search system, a file search method, and a recording medium with a file search program recorded thereon, which are capable of improving the operability of file search.

A file search system according to one aspect of the disclosure includes an acquisition processing unit, a search processing unit, and an output processing unit. The acquisition processing unit acquires a search keyword for searching a predetermined file in a storage storing a plurality of files. The search processing unit searches the predetermined file on the basis of the search keyword acquired by the acquisition processing unit. The output processing unit that outputs a search result of the search processing unit and outputs a degree of relatedness representing a relationship between the search keyword and each of the files stored in the storage on a basis of a score value corresponding to appearance frequency of the search keyword for each of the files.

A file search method executed by one or more processors includes: acquiring a search keyword for searching a predetermined file in a storage storing a plurality of files; searching the predetermined file on a basis of the search keyword; and outputting a search result and outputting a degree of relatedness representing a relationship between the search keyword and each of the files stored in the storage on a basis of a score value of each of the files, corresponding to the number of appearances of the search keyword.

A recording medium containing a file search program that causes one or more processors to: acquire a search keyword for searching a predetermined file in a storage storing a plurality of files; search the predetermined file on a basis of the search keyword; and output a search result and output a degree of relatedness representing a relationship between the search keyword and each of the files stored in the storage on a basis of a score value of each of the files, corresponding to the number of appearances of the search keyword.

The disclosure can provide a file search system, a file search method, and a recording medium with a file search program recorded thereon, which are capable of improving the operability of file search.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a functional block diagram illustrating a configuration of a file search system according to an embodiment of the disclosure.

FIG. 2 is a diagram illustrating an example of an upload page displayed on a user terminal according to an embodiment of the disclosure.

FIG. 3 is a diagram illustrating an example of file information used in the file search system according to an embodiment of the disclosure.

FIG. 4 is a diagram illustrating an example of keyword usage information used in the file search system according to an embodiment of the disclosure.

FIG. 5 is a diagram illustrating an example of important keyword information used in the file search system according to an embodiment of the disclosure.

FIG. 6 is a diagram illustrating an example of file evaluation information used in the file search system according to an embodiment of the disclosure.

FIG. 7 is a diagram illustrating an example of a search page displayed on a user terminal according to an embodiment of the disclosure.

FIG. 8 is a diagram illustrating an example of a search result page displayed on a user terminal according to an embodiment of the disclosure.

FIG. 9 is a diagram illustrating an example of a search result page displayed on a user terminal according to an embodiment of the disclosure.

FIG. 10 is a flowchart for illustrating an example of a procedure of file search processing executed by the file search system according to an embodiment of the disclosure.

### DETAILED DESCRIPTION

Embodiments of the disclosure will be described below with reference to the accompanying drawings. Note that the following embodiments are mere examples that embody the disclosure, and do not intend to limit the technical scope of the disclosure.

File Search System 10

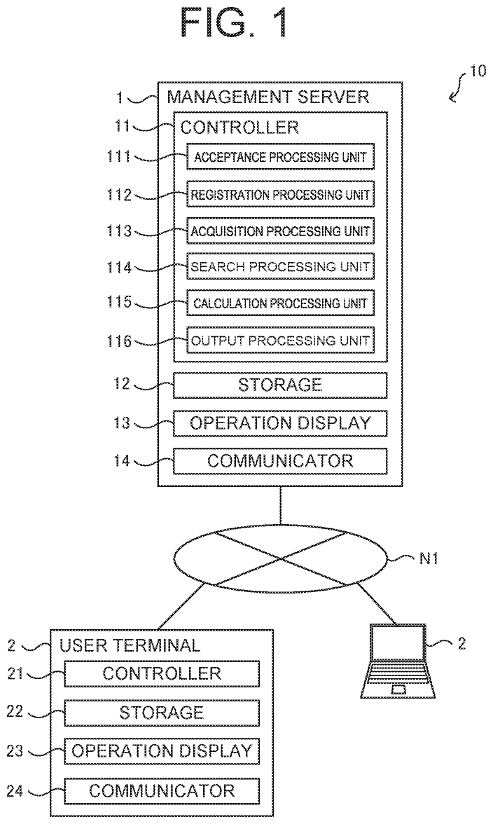

FIG. 1 is a functional block diagram illustrating a configuration of a file search system 10 according to an embodiment of the disclosure. The file search system 10 includes a management server 1 and a user terminal 2. The management server 1 and the user terminal 2 are connected to each other via a network N1 (for example, the Internet, a LAN, etc.). The file search system 10 may include multiple user terminals 2.

In the file search system 10, the management server 1 manages files uploaded from the user terminal 2. The management server 1 provides, to a user, a file management service managing the files stored in a storage 12. For example, the management server 1 manages multiple files stored in the storage 12 such that multiple user terminals 2 can each access the files via the network N1. The management server 1 searches files in response to search requests from each of the user terminals 2 and outputs the search results to the user terminals 2.

The user of each of the user terminals 2 uploads files such as document files created by the user with the corresponding user terminal 2 to the management server 1 by using a predetermined application program (file management application program). Each user makes a request to search files by entering search conditions (search keywords, etc.) by using the file management application program. Each user can access the management server 1 to browse a file and download a file to the user terminal 2.

The file search system 10 is an example of the file search system of the disclosure. Note that the file search system of the disclosure may be composed of the management server 1 alone.

Management Server 1

As illustrated in FIG. 1, the management server 1 includes a controller 11, a storage 12, an operation display 13, a communicator 14 and the like. The management server 1 may be composed of a personal computer, a network attached storage (NAS), or the like.

The communicator 14 is a communication interface for connecting the management server 1 to the network N1 in a wired or wireless manner and executing data communication with a user terminal 2 via the network N1 in accordance with a predetermined communication protocol. The network N1 is composed of, for example, the Internet or a LAN.

The operation display 13 is a user interface including a display such as a liquid crystal display or an organic EL display that displays various pieces of information, and an operation acceptor such as a mouse, a keyboard, or a touch panel that receives an operation.

The storage 12 is a non-volatile storage such as a hard disk drive (HDD), a solid state drive (SSD), or a flash memory, which stores various types of information. The storage 12 stores data including files managed by the management server 1. The storage 12 may be composed of a data server such as a NAS and connected to the management server 1 via the network N1.

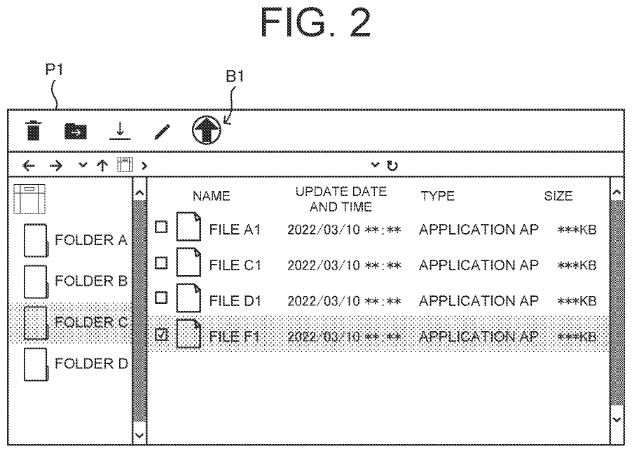

A user runs the file search application program on the user terminal 2 and uploads a desired file to the management server 1. As illustrated in FIG. 2, for example, the user selects a file on an upload page P1 displayed on the user terminal 2 and uploads the file. Specifically, the user opens the upload page P1 in the file management application program on the user terminal 2. The upload page P1 displays a list of files stored in the user terminal 2 in hierarchical structure by folder. FIG. 2 illustrates a state in which a user selects a file F1 stored in a folder C. A user can select one or more files. A user selects the file F1 and presses an upload button Bl. This causes the file F1 to be uploaded to the management server 1. Identification information (user ID, etc.) pertaining to the creator of the file is added to the file F1.

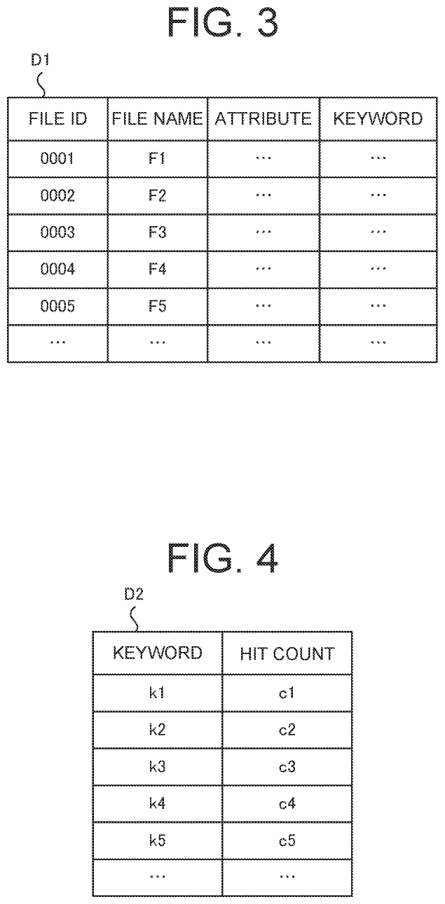

Each user can upload, to the management server 1, a desired file by using the corresponding user terminal 2. The storage 12 stores the file uploaded from each user terminal 2. The storage 12 stores file information D1 pertaining to the file. FIG. 3 illustrates an example of the file information D1. The file information D1 includes pieces of information such as a “file ID”, a “file name”, an “attribute”, and a “keyword” for each file uploaded from the user terminal 2. The file ID is identification information on the file, and the file name is a name set by a user for the file. The attribute is attribute information assigned to the file, such as creator, creation date, size, extension, update date, etc.

The keyword is a predetermined word contained in the file and is index information used in the search process. For example, the keyword is a word separated by parsing by the controller 11. The controller 11 extracts multiple keywords for each file and registers them in the file information D1.

Keyword usage information D2 pertaining to the search count (hit count) of the keywords is stored in the storage 12. FIG. 4 illustrates an example of the keyword usage information D2. As illustrated in FIG. 4, information such as “hit count” for each keyword registered in the file information D1 is registered in the keyword usage information D2. The hit count is the number of times a keyword is used as a search keyword. For example, if a user requests a search by entering “kl” as a search keyword, the hit count “cl” for “kl” is added once. The hit count for each keyword is added each time the keyword is used as a search keyword (in each search process).

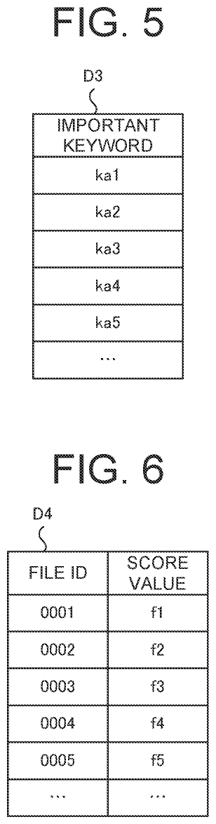

Important keyword information D3 pertaining to important keywords is stored in the storage 12. FIG. 5 illustrates an example of the important keyword information D3. As illustrated in FIG. 5, specified keywords among the keywords registered in the keyword usage information D2 are registered as important keywords in the important keyword information D3. For example, keywords registered in the keyword usage information D2 whose hit count (search count) is equal to or larger than a threshold are registered in the important keyword information D3 as important keywords. That is, the important keywords represent current trending words. The important keywords are updated in accordance with the search process as appropriate.

File evaluation information D4 pertaining to the evaluation of the files in which the file information D1 is stored is stored in the storage 12. FIG. 6 illustrates an example of the file evaluation information D4. As illustrated in FIG. 6, information such as “score value” for each file registered in the file information D1 is registered in the file evaluation information D4. The score value is a value corresponding to the appearance frequency of the search keywords in the file.

Specifically, the controller 11 registers the total number of keywords that match the search keywords entered by a user among all keywords in the file F1 as the score value. For example, if the file F1 contains 30 keywords that match the search keywords, the controller 11 registers “30” in the score value corresponding to the file ID of the file F1. In another embodiment, the controller 11 may register the percentage of keywords matching the search keywords of all keywords in the file F1 as the score value. For example, if the file F1 contains 300 keywords and 30 of them match the search keywords, the controller 11 registers “10%” in the score value corresponding to the file ID of the file F1. Each time a user enters search keywords and makes a search request, the controller 11 calculates the score value for each file and registers it in the file evaluation information D4.

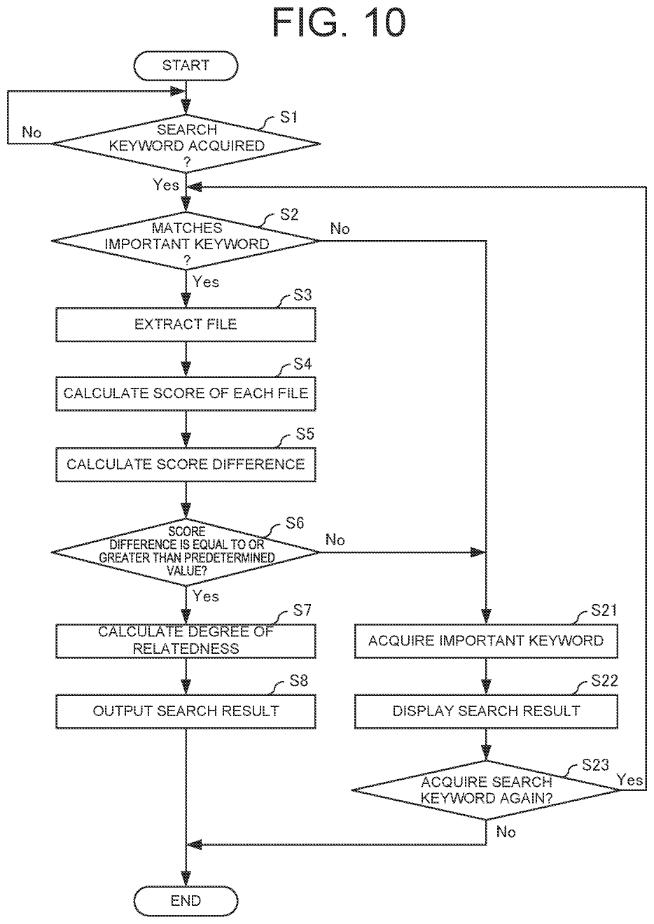

Furthermore, the storage 12 stores a file search program for causing the controller 11 to execute a file search process (see FIG. 10) described later. For example, the file search program is recorded in a computer-readable recording medium such as a CD or a DVD in a non-transitory manner, is read by a reader (not illustrated) such as a CD drive or a DVD drive included in the management server 1, and is stored in the storage 12. The file search program may be distributed from another server and stored in the storage 12.

The controller 11 includes a control device such as a CPU, a ROM, and a RAM. The CPU is a processor that executes various types of arithmetic processing. The ROM stores in advance a control program such as a BIOS or an OS for causing the CPU to execute various types of processing. The RAM stores various pieces of information and is used as a temporary storage memory (work area) for the various types of processing executed by the CPU. The controller 11 controls the management server 1 by causing the CPU to execute various control programs stored in advance in the ROM or the storage 12.

Specifically, as illustrated in FIG. 1, the controller 11 includes various processing units, such as an acceptance processing unit 111, a registration processing unit 112, an acquisition processing unit 113, a search processing unit 114, a calculation processing unit 115, and an output processing unit 116. The controller 11 functions as the various processing units by executing the various types of processing in accordance with the file search program. Some or all of the processing units included in the controller 11 may be composed of an electronic circuit. The file search program may be a program for causing multiple processors to function as the various processing units.

The acceptance processing unit 111 accepts various operations from each user terminal 2. Specifically, the acceptance processing unit 111 accepts a file upload operation on the upload page P1 (see FIG. 2) displayed on the user terminal 2.

For example, the controller 11 causes the upload page P1 to be displayed on the user terminal 2 and causes a list of the files stored in the user terminal 2 to be displayed on the upload page P1. When a user selects a desired file on the upload page P1 (see FIG. 2), the acceptance processing unit 111 accepts the selection operation. When a user selects the file F1 and presses the upload button B 1, the acceptance processing unit 111 accepts an upload operation. When the acceptance processing unit 111 accepts the upload operation, the controller 11 executes an upload process to obtain the file F1 from the user terminal 2.

When the upload process is executed, the registration processing unit 112 acquires the file F1 from the user terminal 2 and stores the file F1 in the storage 12. The registration processing unit 112 registers various pieces of information pertaining to the file F1 in the file information D1 (see FIG. 3). For example, the registration processing unit 112 registers the file ID, the file name, and the attributes (creator, creation date, size, extension, update date, etc.) of the file F1 in the file information D1.

The registration processing unit 112 extracts keywords from the acquired file and registers them in the file information D1. Specifically, when the registration processing unit 112 acquires a file from the user terminal 2, it parses the document in the file into words, compares each word with a word in a dictionary database (not illustrated) to remove noise and correct fluctuations, and extracts the words as keywords. The registration processing unit 112 registers the keywords extracted for each file in the file information D1 in association with that file.

In this way, the registration processing unit 112 acquires a file and registers information pertaining to the file in the file information D1 on the basis of the upload operation performed by each user. The registration processing unit 112 then extracts keywords from the file and registers them in the file information D1.

The registration processing unit 112 updates the keyword usage information D2 (see FIG. 4) and the important keyword information D3 (see FIG. 5) each time it executes a search process in accordance with a search request from a user. Specifically, for each of the keywords registered in the file information D1, the registration processing unit 112 calculates the number of times each keyword was used as a search keyword (search count) and registers it in the keyword usage information D2. For example, when a user enters a search keyword and requests a search once, the registration processing unit 112 updates the hit count (e.g., updates n times to n+1 times) for the keyword that matches the search keyword among the multiple keywords. In this way, the registration processing unit 112 updates the hit count of each word used as a search keyword.

The registration processing unit 112 registers as important keywords the keywords of which the number of matches with the search keywords acquired in past search processes is equal to or larger than a threshold among the multiple keywords contained in the documents of each of the files registered in the file information D1. That is, the registration processing unit 112 extracts keywords of which the hit count equals or exceeds a threshold as important keywords and registers them in the important keyword information D3 (see FIG. 5). This registers keywords that are frequently used by users as important keywords in the important keyword information D3.

Here, when the controller 11 acquires a search request from the user, it executes the following search process and presents the search results to a user.

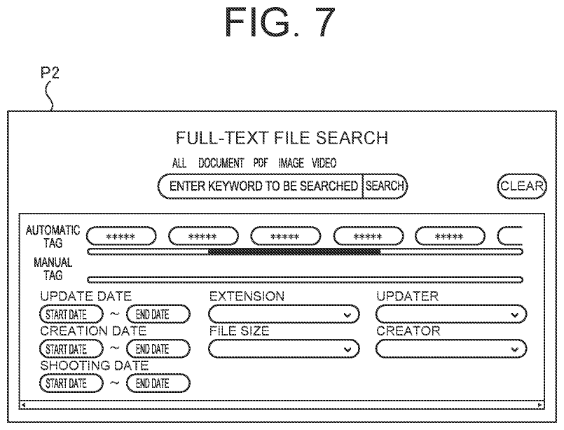

Specifically, the acquisition processing unit 113 acquires search keywords from the user terminal 2 to search a predetermined file in the storage 12 that stores multiple files. For example, on a search page P2 illustrated in FIG. 7, when a user enters search keywords and presses a search button, the acquisition processing unit 113 acquires the search keywords. The user can also set other search conditions (tags, modification date, extension, creator, etc.) on the search page P2.

The search processing unit 114 searches a predetermined file on the basis of the search keywords acquired by the acquisition processing unit 113. For example, the search processing unit 114 determines whether or not the search keywords match important keywords, and if the search keywords match important keywords, it extracts files containing the search keywords from the files stored in the storage 12.

The calculation processing unit 115 calculates score values of the files. Specifically, the calculation processing unit 115 calculates values (score values) corresponding to the appearance frequencies of the search keywords in each of the files containing the search keywords extracted by the search processing unit 114. For example, the calculation processing unit 115 calculates the score values of the files on the basis of the frequencies of the search keywords appearing in the documents in the files. The calculation processing unit 115 registers the score values calculated for the files in the file evaluation information D4 (see FIG. 6).

For example, when the acquisition processing unit 113 acquires the search keywords from the user terminal 2, the calculation processing unit 115 calculates the number of search keywords out of all keywords in the file F1 as the score value. For example, if the file F1 contains 30 keywords that match the search keywords, the calculation processing unit 115 registers “30” in the score value corresponding to the file ID of the file F1.

In another embodiment, when the acquisition processing unit 113 acquires the search keywords from the user terminal 2, the calculation processing unit 115 may calculate the percentage of search keywords of all keywords in the file F1 as the score value. For example, if the file F1 contains 300 keywords and 30 of them match the search keywords, the calculation processing unit 115 calculates the score value corresponding to the file ID of the file F1 to be “10%”.

As another embodiment, the calculation processing unit 115 may calculate the score value of the file on the basis of the frequency of the search keywords appearing in the documents of the file and the frequency of the important keywords appearing in the documents of the file. For example, when the acquisition processing unit 113 acquires the search keywords from the user terminal 2, the calculation processing unit 115 may calculate the score value by calculating the sum (or percentage) of the total number of keywords in the file F1 that match the search keywords and the total number of keywords in the file F1 that match the important keywords (see FIG. 5) out of all keywords in the file F1.

Each time a user enters search keywords and makes a search request, the calculation processing unit 115 calculates the score value for each file and registers it in the file evaluation information D4 (see FIG. 6).

When the calculation processing unit 115 calculates the score value for each file containing the search keywords, the calculation processing unit 115 further calculates the difference (score difference) between the maximum score value and the minimum score value. The calculation processing unit 115 then determines that the search results are appropriate (the search keywords are appropriate) when the score difference is equal to or larger than a predetermined value and determines that the search results are inappropriate (the search keywords are inappropriate) when the score difference is less than the predetermined value.

The output processing unit 116 outputs the search results by the search processing unit 114 and outputs the degree of relatedness representing the relationship between the search keywords and each of the files, based the score values corresponding to the files containing the search keywords. The degree of relatedness is an index representing the degree of appropriateness (validity) of the search keywords. The higher the degree of relatedness, the higher the degree of appropriateness of the search keywords, and the more appropriate (valid) the search results.

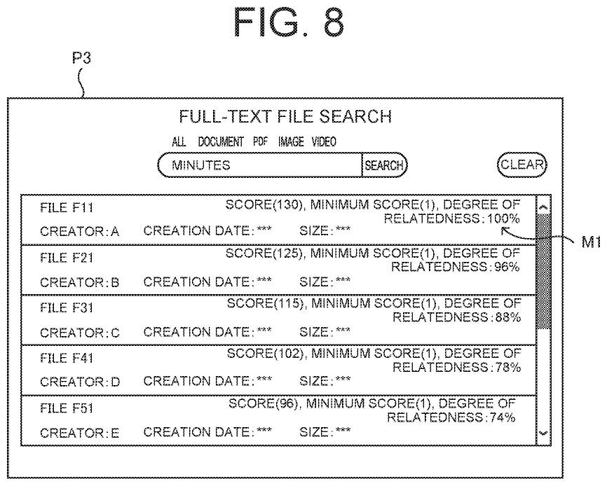

Specifically, the calculation processing unit 115 calculates the degree of relatedness in accordance with the difference between the maximum and minimum score values (score difference) among the score values of the files. For example, the calculation processing unit 115 sets the degree of relatedness of the maximum score value among the score values for the respective files to 100% and calculates the degree of relatedness corresponding to the score values for other files. For example, as illustrated in FIG. 8, if the degree of relatedness of a file F11 having the maximum score value (“130”) is set to “100%”, the calculation processing unit 115 calculates the degree of relatedness of a file F21 having a score value of “125” to be “96%” and the degree of relatedness of a file F31 having a score value of “115” to be “88%”. In this way, the calculation processing unit 115 calculates the degree of relatedness for each of the files extracted by the search processing unit 114 that contain the important keywords.

The output processing unit 116 outputs the search results arranging the files in descending order of the degree of relatedness, to the user terminal 2. For example, as illustrated in FIG. 8, the output processing unit 116 displays a list of files (search results) that contain keywords that match the important keywords in the documents on the search result page P3 and displays evaluation results M1 including the degree of relatedness associated with the files. The evaluation results M1 include the degree of relatedness corresponding to the files, the score values of the files, and the minimum score value. FIG. 8 illustrates the search results when “minutes” is entered as the search keyword.

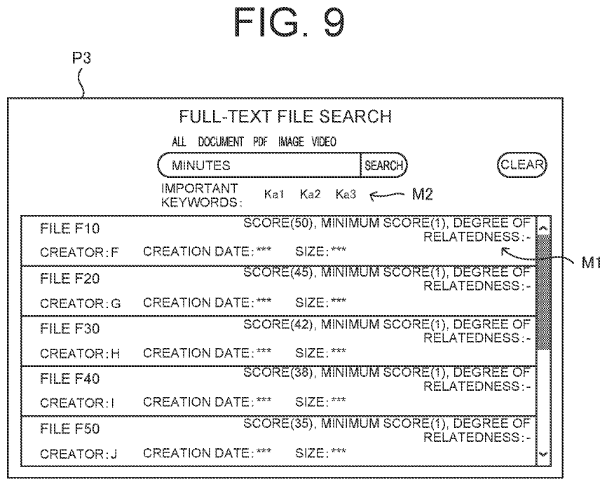

Here, when the score difference is less than a predetermined value, the calculation processing unit 115 determines that the search results are inappropriate (search keywords are inappropriate), and the output processing unit 116 outputs the important keywords in the search results. For example, as illustrated in FIG. 9, the output processing unit 116 displays a list of search results (search files) on the search result page P3 and suggestion information M2 including the important keywords. If the score difference is less than a predetermined value, the output processing unit 116 omits the display of the degree of relatedness. The no display of the degree of relatedness allows users to recognize that the search results are inappropriate (search keywords are inappropriate). The display of the suggestion information M2 prompts users to use the important keywords as search keywords. For example, a user may enter or add important keywords to the search keywords and search again in accordance with the suggestion information M2.

In this way, the output processing unit presents the important keywords to the user and prompts the user to re-enter the search keywords when the score difference is less than a predetermined value.

In another embodiment, if the score difference is less than a predetermined value, the output processing unit 116 may omit the display of the search results illustrated in FIG. 9 and send a message such as a search error to the user terminal 2.

As described above, the management server 1 outputs the degree of relatedness representing the relationship between the search keywords and each of the file on the basis of the score value corresponding to the number of appearances of the search keywords in each file acquired from the user terminal 2 and outputs search results in accordance with the degree of relatedness.

User Terminal 2

As illustrated in FIG. 1, the user terminal 2 includes a controller 21, a storage 22, an operation display 23, and a communicator 24. The user terminal 2 is an information processing device such as a personal computer, a smartphone, or a tablet terminal.

The communicator 24 is a communication interface for connecting the user terminal 2 to the network N1 in a wired or wireless manner and for executing data communication between the user terminal 2 and an external device such as the management server 1 via the network N1 in accordance with a predetermined communication protocol.

The operation display 23 is a user interface that includes: a display, such as a liquid crystal display or an organic EL display, that displays information such as various web-pages; and an operation acceptor, such as a mouse, keyboard, or a touch panel, that accepts an operation.

The storage 22 is a non-volatile storage such as an HDD, an SSD, or a flash memory that stores various types of information. For example, the storage 22 stores control programs such as a browser program. Specifically, the browser program is a control program for causing the controller 21 to execute a communication process with an external device such as the management server 1 in accordance with a communication protocol such as the Hypertext Transfer Protocol (HTTP). The browser program may be a dedicated application program for executing a communication process with the management server 1 in accordance with a predetermined communication protocol.

The controller 21 has control devices such as a CPU, a ROM, and a RAM. The CPU is a processor that executes various types of arithmetic processing. The ROM is a non-volatile storage that preliminarily stores control programs such as a BIOS and an OS for causing the CPU to execute various types of processing. The RAM is a volatile or non-volatile storage that stores various types of information and is used as temporary storage memory (a work area) for various processing executed by the CPU. The controller 21 controls the user terminal 2 by causing the CPU to execute various types of control programs preliminarily stored in the ROM or the storage 22.

Specifically, the controller 21 functions as a browser processing unit by executing various types of processing in accordance with the browser program stored in the storage 22. The controller 21 can cause the operation display 23 to display a web-page provided from the management server 1 via the network N1 and execute browser processing to input an operation to the operation display 23 into the management server 1. That is, the user terminal 2 can function as an operation terminal of the management server 1 when the controller 21 executes the browser program. Some or all of the processing units included in the controller 21 may be configured by an electronic circuit.

When a user operation is performed to request access to a predetermined URL corresponding to the website of the file management service provided by the management server 1, the controller 21 in the user terminal 2 acquires data on the web-page of the website from the management server 1 and displays the web-page of the website on the operation display 23. When a predetermined application program (file management application program) corresponding to the management server 1 is installed on the user terminal 2, the web-page of the website is displayed on the operation display 23 through an operation performed by a user of the user terminal 2 to run the file management application program.

The controller 21 uploads a file stored in the user terminal 2 to the management server 1 in accordance with a user operation. The controller 21 transmits a search request to the management server 1 to search files stored on the management server 1 in response to a user operation. The controller 21 displays the results of the search process by the management server 1. The controller 21 displays the content of the files or downloads the files to the user terminal 2 in response to a selection operation of files included in the search results.

The controller 21 causes the operation display 23 of the user terminal 2 to display web-pages such as the upload page P1 (see FIG. 2), the search page P2 (see FIG. 7), and the search result page P3 (see FIGS. 8 and 9). The controller 21 receives a user operation on each web-page.

File Search Process

With reference to FIG. 10, an example of a procedure of a file search process executed in the file search system 10 will be described.

The disclosure can be considered as a disclosure of a file search method of executing one or more steps included in the file search process. The one or more steps included in the file search process described herein may be omitted as appropriate. The order of execution of the respective steps of the file search process may vary as long as similar effects are provided. A case in which the controller 11 of the management server 1 executes each step in the file search process will be described here as an example, but in other embodiments, one or more processors may execute each step in the file search process in a dispersed manner.

Here, as described in the examples above, it is assumed that multiple files are downloaded from each of the user terminals 2 and stored on the management server 1. It is assumed that the management server 1 stores the file information D1 (see FIG. 3) pertaining to the files, the keyword usage information D2 (see FIG. 4) pertaining to the search count (hit count) of keywords contained in the files, and the important keyword information D3 (see FIG. 5) pertaining to important keywords.

The file search process is executed in parallel in response to search requests from the respective user terminals 2.

First, in step S1, the controller 11 determines whether or not search keywords are acquired from a user terminal 2. If the controller 11 acquires the search keywords from the user terminal 2 (Yes in step S1), the process transitions to step S2. The controller 11 waits until the search keywords are acquired from the user terminal 2 (No in step S1).

In step S2, the controller 11 determines whether or not the search keywords match the important keywords (see FIG. 5). If the search keywords match any of the important keywords registered in the important keyword information D3 (Yes in step S2), the controller 11 causes the process to transition to step S3. If the search keywords match none of the important keywords registered in the important keyword information D3 (No in step S2), the controller 11 causes the process to transition to step S21.

In step S3, the controller 11 extracts files containing the search keywords from the files stored in the storage 12.

Next, in step S4, the controller 11 calculates score values for the extracted files Specifically, the controller 11 calculates values (score values) corresponding to the appearance frequencies of the search keywords contained in the files for each of the files containing the search keywords. For example, the controller 11 calculates the number of appearances of keywords matching the search keywords that appear in the documents of the files as the score values of the files. The controller 11 registers the score values calculated for the files in the file evaluation information D4 (see FIG. 6).

Next, in step S5, the controller 11 calculates the difference (score difference) between the maximum score value and the minimum score value among the score values for each of the files containing keywords matching the search keywords.

Next, in step S6, the controller 11 determines whether or not the score difference is equal to or larger than a predetermined value. If the controller 11 determines that the score difference is larger than or equal to the predetermined value (Yes in step S6), the controller 11 determines that the search results are appropriate (search keywords are appropriate) and causes the process to transition to step S7. If the controller 11 determines that the score difference is smaller than the predetermined value (No in step S6), the controller 11 determines that the search results are inappropriate (search keywords are inappropriate) and causes the process to transition to step S21.

In step S7, the controller 11 calculates degree of relatedness representing the relationship between the search keywords and each of the files, based the score values corresponding to the files containing the search keywords. Specifically, the controller 11 sets the degree of relatedness of the maximum score value among the score values for the respective files to 100% and calculates the degree of relatedness corresponding to the score values for other files (see FIG. 8).

In step S8, the controller 11 outputs the search results to the user terminal 2. Specifically, the controller 11 outputs the search results arranging the files extracted in step S3 in descending order of degree of relatedness, to the user terminal 2. For example, as illustrated in FIG. 8, the controller 11 displays a list of search results of documents including the important keywords (search files) on the search result page P3 and the evaluation results M1 including the degree of relatedness in association with the searched files.

In step S21, the controller 11 acquires important keywords from the important keyword information D3 (see FIG. 5). Next, in step S22, the controller 11 outputs the search results to the user terminal 2. For example, as illustrated in FIG. 9, the controller 11 displays a list of search results on the search result page P3 and the suggestion information M2 including the important keywords. Here, the degree of relatedness is not displayed on the search result page P3. In this way, when the search keywords acquired in step S1 do not match the important keywords (No in step S2) or when the score difference is less than a predetermined value in step S6 (No in step S6), the controller 11 presents to users the important keywords acquired from the important keyword information D3 (see FIG. 5). The controller 11 may present one or more important keywords among the important keywords registered in the important keyword information D3, whose hit count exceeds or equals a set value (where the set value is larger than the threshold).

Next, in step S23, the controller 11 determines whether or not search keywords are reacquired from a user terminal 2. If the controller 11 reacquires the search keywords from the user terminal 2 (Yes in step S23), the process transitions to step S2. If the controller 11 does not reacquire the search keywords from the user terminal 2 (S23: No), the controller 11 ends the file search process.

If the reacquired search keywords match the important keywords (Yes in S2), the controller 11 executes step S3 and the subsequent processes.

In step S8, the controller 11 outputs the search results to the user terminal 2 and ends the file search process. Then, when a user selects a desired file on the search result page P3 (see FIG. 8), the controller 11 causes the user terminal 2 to display the contents of the files (documents) or downloads the files to the user terminal 2.

As described above, the controller 11 executes the file search process. The controller 11 executes the file search process each time it acquires the search keywords from each user terminal 2.

As described above, the file search system 10 according to the present embodiment acquires search keywords to search a predetermined file in the storage 12 that stores multiple files and searches the predetermined file on the basis of the acquired search keywords. The file search system 10 outputs the search results and the degree of relatedness representing the relationship between the search keywords and each of the files on the basis of the score value corresponding to the number of appearances of the search keywords for each of the files stored in the storage 12.

Specifically, the file search system 10 uses parsing and a dictionary for the stored files (document files) to identify important keywords and registers keywords used in the files in descending order of their frequency.

The file search system 10 performs a full-text search on the basis of the entered search keywords. When the search keywords are included in the important keywords, the file search system 10 outputs the search keywords as higher-level search results. At this time, the file search system 10 calculates a score value for each file on the basis of hit accuracy and further calculates the difference between the maximum and minimum score values (score difference).

The file search system 10 determines that the search is correctly made when the score difference is large and that the search is not correctly made when the score difference is small.

The file search system 10 displays the score values and the degree of relatedness calculated from the score difference on the search result page P3 (see FIG. 8). The file search system 10 may further display the hit count on the search result page P3.

When the score difference is less than a predetermined value, the file search system supplements the important keywords and suggests them to the user. When the score difference is less than the predetermined value, the file search system 10 may additionally suggest important keywords and an experience thesaurus related to the original search keywords. In addition to a conventional thesaurus, the experience thesaurus keeps a group of search keywords specified by the user at the time of search as a new relationship and adds them as related keywords at the time of suggestion when the number of inputs is large.

In this way, keywords are periodically extracted on the basis of the files stored in the storage 12 (NAS, etc.). The search count (hit count) for each keyword is recorded as a regular task in the storage 12 (see FIG. 4). Keywords whose search count is equal to or larger than a threshold are registered as important keywords (see FIG. 5). The file search system 10 then uses the score value as a guide to the validity of the search results when a full-text search is performed by using search keywords in a system that performs a full-text search of files stored in the storage 12 (NAS, etc.). The score value is calculated on the basis of hit accuracy, with files with higher-order search results having higher score values and files with lower-order search results having lower score values. Furthermore, by checking the difference between the maximum and minimum score values (score difference), it is determined that the expected result is obtained when the score difference is large. On the other hand, when the score difference is small, it is determined that the expected result is not obtained, and important keywords (see FIG. 5) that are preliminarily registered as search indexes are suggested to the user to lead the user to perform a search again.

With the file search system 10 according to the present embodiment, for example, more search keywords contained in a file provides a higher score value. The higher the score value of a file, the higher relationship (degree of relatedness) between the file and the search keywords. Presenting the degree of relatedness to a user allows users to determine whether or not the search results are appropriate (search keywords are appropriate). In this way, for example, when the degree of relatedness is high, a user can determine that the search results are appropriate (the search keywords are appropriate) and obtain the desired file. On the other hand, when the degree of relatedness is low, a user can determine that the search results are inappropriate (the search keywords are inappropriate) and re-enter the search keywords to make a search request. In this case, the user can perform search again by using the suggested important keywords. As described above, the file search system 10 according to the present embodiment can improve the operability of file search.

The present disclosure is not limited to the above-described embodiments. The disclosure may include the following embodiments.

In the embodiments described above, the controller 11 determines that the search results are appropriate (the search keywords are appropriate) when the difference between the maximum and minimum score values (score difference) is equal to or larger than a predetermined value and determines that the search results are inappropriate (the search keywords are inappropriate) when the score difference is less than the predetermined value. As another embodiment, the controller 11 may determine whether or not the search results are appropriate on the basis of score values within a predetermined range. For example, the controller 11 excludes files having score values smaller than a set value and determines that the search results are appropriate when the score difference between the maximum and minimum score values is equal to or larger than a predetermined value in multiple files having score values larger than a set value. Since this allows, for example, the exclusion of files having a very small number of the search keywords in the file (such as files that may be noise), the reliability of the process of determining whether or not the search results are appropriate can be increased.

As another embodiment of the disclosure, when the controller 11 suggests the important keywords to a user as suggestion information M2, the controller 11 may suggest important keywords to the user in accordance with the attributes of the user. For example, the controller 11 may extract important keywords that are related to the user affiliation (company, department, team, etc.) among multiple important keywords (see FIG. 5) and suggest them to the user. The user attribute can be identified on the basis of user information (not illustrated) or the like that is registered with the file search system 10. The controller 11 may suggest important keywords related to the search keywords entered by a user to the user. This makes it easier for the user to obtain the search results desired by the user.

The search target of the disclosure is not limited to document files, but may also be image files, audio files, etc. The search target is not limited to files, but may be data (information) in various formats.

### Supplementary Notes of Disclosure

An outline of the disclosure derived from the above embodiments will be described below as supplementary notes. The respective configurations and the processing functions described in the following supplementary notes can be selected to be added or omitted and combined arbitrarily.

Supplementary Note 1

A file search system including: an acquisition processing circuit that acquires a search keyword for searching a predetermined file in a storage storing a plurality of files; a search processing circuit that search the predetermined file on a basis of the search keyword acquired by the acquisition processing circuit; and an output processing circuit that outputs a search result of the search processing circuit and outputs a degree of relatedness representing a relationship between the search keyword and each of the files stored in the storage on a basis of a score value corresponding to appearance frequency of the search keyword, the score value corresponding to each of the files.

Supplementary Note 2

The file search system according to Supplementary note 1, further including a calculation processing circuit that calculates the score value of each of the files, wherein the calculation processing circuit calculates the score value for each of the files on a basis of the number of appearances of the search keyword appearing in a document in each of the files.

Supplementary Note 3

The file search system according to Supplementary Note 1 or 2, further including a registration processing circuit that registers as an important keyword a keyword of which the number of matches with the search keyword acquired in a past search process is equal to or larger than a threshold among a plurality of keywords included in document of each of the files stored in the storage.

Supplementary Note 4

The file search system according to Supplementary Note 3, wherein the calculation processing circuit calculates the score value of each of the files on a basis of the number of appearances of the search keyword appearing in the document of each of the file and the number of appearances of the important keyword appearing in the document of each of the files.

Supplementary Note 5

The file search system according to any one of Supplementary Notes 2 to 4, wherein the calculation processing circuit calculates the degree of relatedness in accordance with a difference between a maximum score value and a minimum score value among the score values of the files.

Supplementary Note 6

The file search system according to Supplementary Note 5, wherein the output processing circuit presents the important keyword to a user and prompts the user to re-enter the search keyword when the difference is less than a predetermined value.

Supplementary Note 7

The file search system according to any one of Supplementary Notes 1 to 6, wherein the output processing circuit displays the search result in descending order of degree of relatedness when the difference is larger than a predetermined value.

Supplementary Note 8

The file search system according to any one of Supplementary Notes 1 to 7, wherein the output processing circuit displays the score value and the degree of relatedness corresponding to each of the files in the search result in association with file information of the files.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A file search system comprising:
an acquisition processing circuit that acquires a search keyword for searching a predetermined file in a storage storing a plurality of files;
a search processing circuit that search the predetermined file on a basis of the search keyword acquired by the acquisition processing circuit; and
an output processing circuit that outputs a search result of the search processing circuit and outputs a degree of relatedness representing a relationship between the search keyword and each of the files stored in the storage on a basis of a score value corresponding to appearance frequency of the search keyword, the score value corresponding to each of the files.

2. The file search system according to claim 1, further comprising:
a calculation processing circuit that calculates the score value of each of the files, wherein
the calculation processing circuit calculates the score value for each of the files on a basis of the number of appearances of the search keyword appearing in a document in each of the files.

3. The file search system according to claim 2, further comprising:
a registration processing circuit that registers as an important keyword a keyword of which the number of matches with the search keyword acquired in a past search process is equal to or larger than a threshold among a plurality of keywords included in the document of each of the files stored in the storage.

4. The file search system according to claim 3, wherein the calculation processing circuit calculates the score value of each of the files on a basis of the number of appearances of the search keyword appearing in the document of each of the file and the number of appearances of the important keyword appearing in the document of each of the files.

5. The file search system according to claim 4, wherein the calculation processing circuit calculates the degree of relatedness in accordance with a difference between a maximum score value and a minimum score value among the score values of the files.

6. The file search system according to claim 5, wherein the output processing circuit presents the important keyword to a user and prompts the user to re-enter the search keyword when the difference is less than a predetermined value.

7. The file search system according to claim 1, wherein the output processing circuit displays the search result in descending order of degree of relatedness when the difference is larger than a predetermined value.

8. The file search system according to claim 7, wherein the output processing circuit displays the score value and the degree of relatedness corresponding to each of the files in the search result in association with file information of the files.

9. A file search method executed by one or more processors, the method comprising:
acquiring a search keyword for searching a predetermined file in a storage storing a plurality of files;
searching the predetermined file on a basis of the search keyword; and
outputting a search result and outputting a degree of relatedness representing a relationship between the search keyword and each of the files stored in the storage on a basis of a score value of each of the files, corresponding to the number of appearances of the search keyword.

10. A non-transitory computer-readable recording medium containing a file search program that causes one or more processors to:
acquire a search keyword for searching a predetermined file in a storage storing a plurality of files;
search the predetermined file on a basis of the search keyword; and
output a search result and output a degree of relatedness representing a relationship between the search keyword and each of the files stored in the storage on a basis of a score value of each of the files, corresponding to the number of appearances of the search keyword.
